(19) United States
(12) Patent Application Publication
(10) Pub. No.: US 2004/0210757 A1
(43) Pub. Date: Oct. 21, 2004

(54) Method and a system for unauthorized vehicle control

(76) Inventors: Noam Kogan, Raanana (IL); Edan Almog, Herzliya (IL)

Correspondence Address: BROWDY AND NEIMARK, P.L.L.C., 624 NINTH STREET, NW, SUITE 300, WASHINGTON, DC, 20001-5303, US

(21) Appl. No.: 10/761,423

(22) Filed: Jan. 22, 2004

(30) Foreign Application Priority Data
Jan. 23, 2003 (IL) 154091

(51) Int. Cl. H04L 9/00

(52) U.S. Cl. 713/182

(57) ABSTRACT

A security method and system for the detection and/or control of unauthorized vehicles among a large number of free flowing authorized vehicles within a controlled geographical zone, incorporating roadside infrastructure, electronic means in vehicles, vehicle to roadside communication, and cryptographic protection against forgery, aiding the interception of unauthorized vehicles by enforcement authorities.

The present invention relates to electronic identification and authentication security methods and systems for the detection and/or control of unauthorized vehicles among a large number of free flowing authorized vehicles within a controlled geographical zone, with a high level of forgery proof protection. This field is henceforth referred to as Unauthorized Vehicle Control.

It is common for authorities to require vehicles moving within the boundaries of their jurisdiction to be authorized and bear evidence of their authorization. Authorities requiring vehicle authorization range from countries and states to organizations of varying sizes, in control of an area where vehicle traffic exists. Unauthorized vehicles are often used for illegal purposes such as acts of crime and hostility, in order to conceal and camouflage the perpetrator's identity. These techniques have long played a major role in aiding acts of crime, and more recently in acts of terrorism. The enforcement of vehicle authorization requirements can play an important role in the solution for the demanding and increasing security needs in various parts of the world.

Unauthorized vehicles can be roughly categorized according to their origins: stolen vehicles, smuggled vehicles, unlicensed vehicles, for example built in a pirate fashion, vehicles with an expired license, vehicles with a revoked license, for example as a result of an accident, vehicles with limited access to certain areas or other restrictions, and vehicles that have been linked to illegal acts by enforcement authorities.

The difficulty in achieving effective control of unauthorized vehicles derives from the need to identify a very small minority of unauthorized vehicles, among a large number of free-flowing authorized vehicles within a large geographical zone containing a complex road network.

The traditional means used by law enforcement and security authorities to address the problem of Unauthorized Vehicle Control typically consist of visually checking the vehicle license and license plate, both of which are unfortunately easily forged. Such means require the vehicles to be designated for checking at random or by appearance, which are notably inefficient, or as a result of intelligence collected by investigation, which is time and resource consuming without guaranteed success. These methods are sometimes accompanied with radio communications to an operations center for verification of the vehicle's status. Unfortunately, reality shows that these methods do not manage to contain the unauthorized vehicles existence at negligible levels, although several different fields of application have been developed in the past in order to perform some kind of vehicle control.

A first example of such a field can be found in access control for vehicles, in which various methods and systems have been developed in order to grant automatically the entrance of authorized vehicles into a controlled zone. In a typical system of such type, the vehicles or the drivers are equipped with an identification device that, when recognized by a reader, whether through an electrical connection or by electro-magnetic means, grant entry permission to the vehicle into the controlled zone. Such a system is for instance described in U.S. Pat. No. 4,665,395.

However, none of the solutions proposed for access control for vehicles solve the addressed problem of Unauthorized Vehicle Control for various reasons. First, they only deal with the movement of vehicles into and out of the controlled zone, which does not address the situation of the vehicles inside the road network in the controlled zone. Secondly, they frequently require vehicles to stop, which severely limits the capacity of the system for the purpose of Unauthorized Vehicle Control.

In another field, in order to electronically collect tolls on highways various methods and systems have been developed. In the proposed solutions, in order to be able to pass an entrance gate into a highway or equivalent zone, a vehicle must be equipped with an electronic device, such as an electronic tag. When identified, whether by an electrical connection or by electromagnetic means, the toll can be debited, and the vehicle is allowed to enter the controlled zone, in this case a highway. These systems have flourished in recent years, achieving the capacity to perform in full vehicle speed together with the capability of handling multi-lane traffic, in conjunction with a backup identification mechanism for debiting vehicles without electronic devices, thus eliminating the need for a physical entrance barrier. Such systems are for instance described in U.S. Pat. Nos. 5,485,520 and 5,422,473.

However, none of the proposed solutions for toll collection solve the addressed problem of Unauthorized Vehicle Control for various reasons. The proposed electronic toll collection solutions incorporating an obstructive barrier are obviously not suitable for Unauthorized Vehicle Control of free flowing traffic. On the other hand, the proposed free flowing traffic electronic toll collection solutions, rely exclusively on a backup vehicle identification mechanism for identifying and debiting vehicles which were not successfully identified by the primary identification mechanism, for example vehicles without tags, typically by performing an optical character recognition algorithm on an acquired image of the license plate. These backup identification mechanisms are easily overcome by forgery, for example forgery of the license plate in order to camouflage the vehicle's identity, and in any case are only adequate for protecting against minor offences, and inadequate for the purpose of Unauthorized Vehicle Control.

In another field, that is to say vehicle fleet management, various methods and systems have been developed. Indeed, fleet management is important in order to optimize the operations of truck delivery companies, post office cars, firemen trucks, taxis, etc. In one typical arrangement, the controlled vehicles are equipped with a localization device such as a GPS receiver, and a radio device which transmits the position of the vehicle to a central unit via an infrastructure of for example base stations or communication satellites, while in another typical arrangement, the vehicles are equipped with a radio device transmitting the identity of the vehicle to an infrastructure of for example base stations or communication satellites, the vehicle's position being determined in this case according to the geometry of the antenna or antennas receiving the vehicle transmission and possibly also the relative times of reception, the determined position being sent to a central unit. Such systems are for instance described in PCT patent number WO 02/075667 A1, and U.S. Pat. No. 5,432,841.

However, none of the proposed solutions for fleet management solve the addressed problem of Unauthorized Vehicle Control since any vehicle that has not been equipped as described above can circulate freely on the road network, as would be the case for instance for a smuggled or pirately constructed vehicle. Furthermore, in such systems, if the radio device in the vehicle is disconnected or demolished, the system is unable to neither identify the vehicle, nor find its' location.

In still another field, that is to say vehicle theft detection, various methods and systems have been developed. In proposed solutions, the vehicles are equipped with a radio device, which is activated in case of theft of the vehicle, resulting either in the immobilization of the vehicle or the transmission of its position to a central unit via an infrastructure of for example base stations or communication satellites in order to allow the intervention of security and law enforcement authorities. Such systems are for instance described in U.S. Pat. Nos. 5,801,618 and 5,661,473.

However, none of the proposed solutions for vehicle theft detection solve the addressed problem of Unauthorized Vehicle Control since any vehicle that has not been equipped as described above can circulate freely on the road network, as would be the case for instance for a smuggled or pirately constructed vehicle. Furthermore, in such systems, if the radio device in the vehicle is disconnected or demolished, the system is unable to neither identify the vehicle, nor find its' location.

In still another field, that is to say electronic license plates, various systems and methods have been proposed. In the proposed solutions, the vehicles are equipped with a device that electronically displays the vehicle license number or electronically transmits it to remote stations, means being planned to prevent the displacement of the device and mounting it on another vehicle. Such systems are for instance described in U.S. Pat. Nos. 5,608,391 and 5,657,008.

However, none of the proposed solutions for electronic license plates solve the addressed problem of Unauthorized Vehicle Control since they have no effective means of dealing with unauthorized vehicles for which the electronic display has been forged and the transmitter has been disconnected or demolished, both of which can easily be performed by perpetrators.

The present invention solves the problem of Unauthorized Vehicle Control without any of the weaknesses found in the prior art. It uses a completely different approach, by continuously monitoring the authorization of all the vehicles moving throughout the road network all the time.

According to the invention, a security method for the detection and/or control of unauthorized vehicles (10a, 10b, . . . ) among a large number of authorized vehicles (12a, 12b, . . . ) within a controlled geographical zone (2), is characterized in that all authorized vehicles are equipped with active licenses (60a, 60b, . . . ) planned to perform a cryptographic action involving a secret cryptographic key (64), and the controlled geographical zone is equipped with automatic control points (20a, 20b, . . . ), and optionally with manual control points (40a, 40b, . . . ), each automatic control point detecting all vehicles crossing a specific road section (21) in its vicinity, and each manual control point selecting vehicles by the action of an operator, the vehicles detected by the automatic control points and the vehicles selected by the manual control points being hereafter referred to as designated vehicles, both types of control points being planned to acquire the results of said cryptographic actions performed by the active licenses of said designated vehicles, a cryptographic authentication algorithm involving a validation key (74) being further performed upon each acquired said result, both types of control points being further planned to associate said acquired results to said designated vehicles, the designation of the vehicles, the acquiring of said results, and the performing of the cryptographic authentication algorithm upon said acquired results not requiring a substantial change in the motion conditions of the vehicles, in particular their velocity, classifying as unauthorized at least vehicles which have been designated but whose said results either have not been acquired or have not been cryptographically authenticated, an alert message being transmitted to enforcement authorities for each vehicle which has been classified as unauthorized, allowing in such a way for an immediate intervention and a possible interception of the unauthorized vehicles, at least some of the control points, hereafter referred to as particular control points, being moreover planned to acquire physical characteristics of said designated vehicles, allowing their direct recognition, said alert message including in this case said physical characteristics.

In preferred embodiments of the invention, one has recourse to one or several of the following:

In a method according to the invention, at least some of said active licenses, hereafter referred to as particular active licenses, additionally have distinct identities (62a, 62b, . . . ), each distinct identity belonging to a group of one or more of said particular active licenses, and distinct identity determination being further performed for all designated vehicles bearing said particular active licenses, upon each said acquired result.

In a method according to the invention, said controlled geographical zone contains one or more sub-zones, each vehicle being further authorized or unauthorized for each of the sub-zones, each sub-zone being further equipped with automatic control points and optionally with manual control points, a database (180) of authorization data regarding said particular active license distinct identities being associated with each sub-zone, each determined distinct identity of a vehicle designated by a control point being further checked against said authorization data in the databases associated with the sub-zones containing that control point, said databases being automatically and/or manually modifiable by the enforcement authorities, additionally classifying as unauthorized vehicles which have been designated but whose said distinct identities are indicated as unauthorized by said authorization data in at least one of the databases associated with the sub-zones containing that control point.

In a method according to the invention, data regarding said designated vehicles (such as said particular active licenses distinct identities, control points location, times of designation of vehicles) is additionally recorded, this data being searched for inconsistencies with regard to time and/or vehicles location, the results of this search assisting enforcement authorities in finding potential impersonations of said particular active licenses.

In a method according to the invention, said secret cryptographic keys of at least some of said particular active licenses are distinct, each distinct key corresponding to a group of one or more said particular active license distinct identities, this, according to the level of protection required for those said particular active licenses, correspondence between said distinct secret cryptographic keys and said distinct identities being additionally required in order to cryptographically authenticate said results, so that a perpetrator in possession of a particular active license, is prevented from impersonating a particular active license with a different distinct secret cryptographic key.

In a method according to the invention, said alert messages are prioritized, according to the control point characteristics, such as its location, alert message history, and/or the time of designation of the vehicle, and/or the said acquired physical characteristics if available, and/or current operational intelligence if available, improving the effectiveness of the intervention of the enforcement authorities.

In a method according to the invention, drivers of vehicles that are classified as unauthorized, are selectively notified immediately upon the vehicles' classification by means (32) of sending a notification in the control points and means (56) of notification in the vehicle communication units.

In a method according to the invention, at least some of the authorized vehicles are additionally provided with removable supports containing at least said secret cryptographic keys.

In a method according to the invention, at least some of the authorized vehicles are additionally provided with supports containing at least said secret cryptographic keys, these supports planned to prevent a perpetrator from finding out, through physical penetration and/or deduction, the secret cryptographic keys they contain.

In a method according to the invention, at least some of the authorized vehicles are additionally provided with supports containing at least said secret cryptographic keys, these supports being physically attached to said authorized vehicles, in a manner preventing their physical displacement from the vehicles and/or causing their destruction and/or eliminating the said secret cryptographic keys from said supports, in case of an unauthorized displacement attempt.

In a method according to the invention, at least some of the authorized vehicles are additionally provided with supports containing at least said secret cryptographic keys, in such a way that all the information produced during said cryptographic action leading to a possible disclosure of said secret cryptographic keys, being exclusively contained in said supports.

In a method according to the invention, at least some of said active licenses are additionally associated to PINs (Personal Identification Numbers), said PINs supplied to said active licenses by users in possession of authorized vehicles, said PINs being additionally required by said active licenses in order to generate said results of said cryptographic action, and/or being further required in order to cryptographically authenticate said results.

In a method according to the invention, digital elements of a first type are used in performing the cryptographic actions of at least some of said active licenses, said digital elements of the first type being additionally required in order to cryptographically authenticate said acquired results, said digital elements of the first type being furthermore different at different times, preventing in this way the authentication of recorded and replayed said results.

In a method according to the invention, said digital elements of the first type are based on the outputs of time clocks.

In a method according to the invention, said digital elements of the first type are acquired by the control points and transmitted to said designated vehicles.

In a method according to the invention, said digital elements of the first type are the elements of predefined series associated with distinct identities.

In a method according to the invention, digital elements of a second type are generated by at least some of said active licenses, are used in performing the cryptographic actions of these particular active licenses, and are required to be different at different times in order to cryptographically authenticate said results of these particular active licenses, preventing in this way the authentication of recorded and replayed said results.

In a method according to the invention, said control points are moreover planned to acquire a credential from the active license of each said designated vehicle, said validation key being securely extracted from each acquired credential by performing a cryptographic extraction algorithm involving an extraction key.

In a method according to the invention, said validation key is selected from a list of validation keys, according to said determined distinct identity.

In a method according to the invention, the cryptographic process consisting of said cryptographic actions in said active licenses and said cryptographic authentications of said acquired results, is of a symmetric type, an asymmetric type, or a combination of both.

In a method according to the invention, at least some of said control points are further planned to associate each said acquired result to a particular designated vehicle.

In a method according to the invention, the memory contents of said active licenses can be altered as a consequence of instructions and/or data transmitted from the control points.

In a method according to the invention, at least some of said authorized vehicles are additionally provided with second active licenses (60/2a, 60/2b, . . . ), the first ones (60a, 60b, . . . ) being hereafter referred to as first active licenses, said second active licenses being planned to perform a second cryptographic action involving a second secret cryptographic key, these authorized vehicles being also provided with removable supports containing at least said second secret cryptographic keys of said second active licenses, at least some of the control points being additionally planned to perform dual interrogation mode, in which these control points further acquire the results of said second cryptographic actions performed by the second active licenses of said designated vehicles, hereafter referred to as second results, and a second cryptographic authentication algorithm involving a second validation key, being further performed upon each acquired said second result, additionally classifying as unauthorized vehicles which have been designated but whose said second results either have not been acquired or have not been cryptographically authenticated.

In a method according to the invention, predetermined correspondences between said first active licenses and said second active licenses are planned, additionally classifying as unauthorized vehicles, which have been designated by a control point in dual interrogation mode, for which said predetermined correspondences have not been verified.

The invention also covers a system that implements the above method, which comprises:

in all authorized vehicles a vehicle communication unit (50), comprising means (52) of activating the transmission of an identification message by the vehicle communication unit, an active license (60) containing a distinct identity (62), and a transmitter (54),

means of issuing (170), and of revoking (178) of active licenses (60a, 60b),

at least one database (180) containing authorization data regarding vehicles,

automatic control points (20a, 20b, . . . ), and optionally manual control points (40a, 40b, . . . ), both distributed in the controlled geographical zone (2), each automatic control point comprising means (22) of detection of all vehicles crossing a specific road section (21) in its vicinity, and each manual control point comprising means (42) of selection of vehicles by the action of an operator, the vehicles detected by the automatic control points and the vehicles selected by the manual control points being hereafter referred to as designated vehicles, both types of control points additionally comprising means (24) of activating requests for identification to the vehicle communication units of the designated vehicles, means (26) of reception capable of receiving identification messages transmitted by vehicle communication units, hereafter referred to as vehicle communication unit responses (90a, 90b, . . . ), and a controller (28) capable of associating vehicle communication unit responses to designated vehicles,

means (130) of retrieving prior data from the database (180),

means (140) of classification of designated vehicles,

at least one operations center (160),

additional means (44) in the manual control points of notifying the manual control point operator,

a communication network (100) between at least some of the control points, the database (180), the means of issuing (170) and revoking (178) of active licenses, the means of retrieving prior data (130), the means of classification (140), and the operations centers,

and which is characterized in that:

I) The active license (60) contains in addition a secret cryptographic key (64) associated to the distinct identity (62) of the active license (60), and is planned to perform a cryptographic confirmation algorithm (66) involving at least the distinct identity (62) and the secret cryptographic key (64),

II) The vehicle communication unit response (90) comprises the result of the cryptographic confirmation algorithm (66),

III) Means (70) of cryptographic authentication are planned to check for each vehicle communication unit response (90) whether or not the secret cryptographic key (64) corresponding to the distinct identity (62) contained in the vehicle communication unit response (90) was the one used in the calculation of this response (90), this action involving a validation key (74) corresponding to the same distinct identity (62), and a cryptographic validation algorithm (76),

IV) For every newly authorized vehicle, the means (170) of issuing allocate a distinct identity (62), initialize a new active license (60) to bear the allocated distinct identity (62) and a corresponding secret cryptographic key (64), and update the database (180) with information regarding the newly authorized vehicle (12),

V) The means (178) of revoking are planned to automatically (for example time dependent expiration) and/or manually modify elements in the database (180), particularly those included in a list of distinct identities of active licenses in authorized vehicles' vehicle communication units, hereafter referred to as authorized vehicle list (182), and/or a list of distinct identities of active licenses in unauthorized vehicles' vehicle communication units, hereafter referred to as unauthorized vehicle list (184),

VI) The means of retrieving prior data (130) utilize the distinct identity (62) contained in the vehicle communication unit response (90), in order to retrieve from the database (180), authorization data regarding this vehicle,

VII) The means (140) of classification utilize the data produced by the means (22) of detection, and/or the means (26) of reception, and/or the controller (28), and/or the means (70) of authentication, and/or the means (130) of retrieving prior data, to determine whether a designated vehicle is authorized or not,

VIII) Means (150) of alert convey to at least one operations center (160) and/or to the means (44) of notifying the manual control point operator, an alert message containing the data provided by the means (26) of reception, and/or the controller (28), and/or the means (70) of authentication, and/or the means (130) of retrieving prior data, for at least some of the vehicles classified as unauthorized,

IX) At least some of the control points comprise in addition means (30) of acquiring physical characteristics of designated vehicles, such as photographic information, plate number, color, vehicle type, weight, the means of alert (150) additionally include said acquired physical characteristics in at least some of the alert messages,

In more preferred embodiments of the invention, one has recourse to one or several of the following:

In a system according to the invention, the means (70) of authentication are additionally planned to determine the validation key (74), by utilizing the distinct identity (62) contained in the vehicle communication unit response (90), to select from a validation key list (80) containing for each distinct identity (62) a corresponding validation key (74), and the means (170) of issuing are also additionally planned to update for every newly authorized vehicle (12) the validation key list (80) with the allocated distinct identity (62) and the corresponding validation key (74).

In a system according to the invention, the vehicle communication unit response (90) additionally comprises a credential (174), the means (70) of authentication being additionally planned to determine the validation key (74), by utilizing a cryptographic extraction algorithm (86) involving an extraction key (78), in order to securely extract the validation key (74) from the credential (174) contained in the vehicle communication unit response (90), and the means (170) of issuing being also additionally planned to initialize for every newly authorized vehicle (12), the active license (60) with a credential (174) containing the result of a cryptographic binding algorithm (176) involving the validation key (74) and a binding key (172) which corresponds to the extraction key (78).

In a system according to the invention, the means (24) of activating requests for identification transmit to every designated vehicle an interrogation message.

In a system according to the invention, the means (24) of activating requests for identification comprise a trigger element in the vicinity of the control point, that is planned to be detectable by means (52) in the vehicle communication units.

A system according to the invention, which is utilized to perform additional functions such as Electronic Toll Collection, Access Control, in particular on the perimeter of the controlled geographical zone and/or any of its sub-zones, Vehicle Messaging, Fleet Management, traffic law enforcement, statistical survey, a crime investigation tool.

The invention will now be described in more detail by referring to the figures given here in a purely illustrative way:

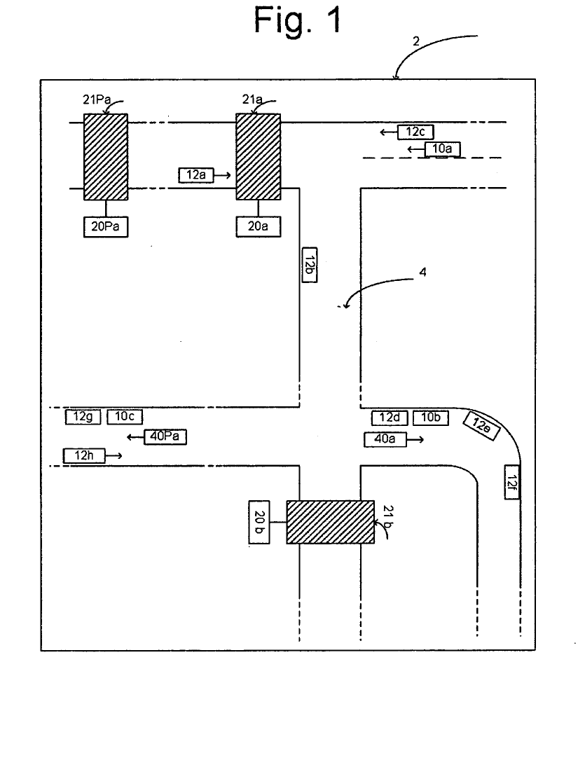

FIG. 1 is a general outline of a controlled geographical zone, in which the method and/or the system according to the invention is implemented for the detection and/or control of unauthorized vehicles, among a large number of authorized vehicles;

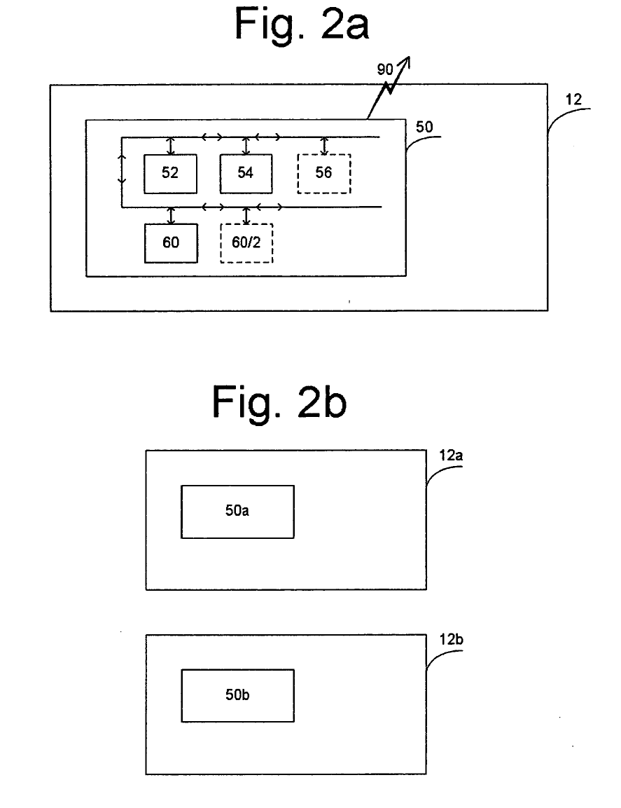

FIG. 2a is an exploded schematic diagram of the vehicle communication unit inside an authorized vehicle of the present invention;

FIG. 2b, shows authorized vehicles bearing vehicle communication units of the present invention;

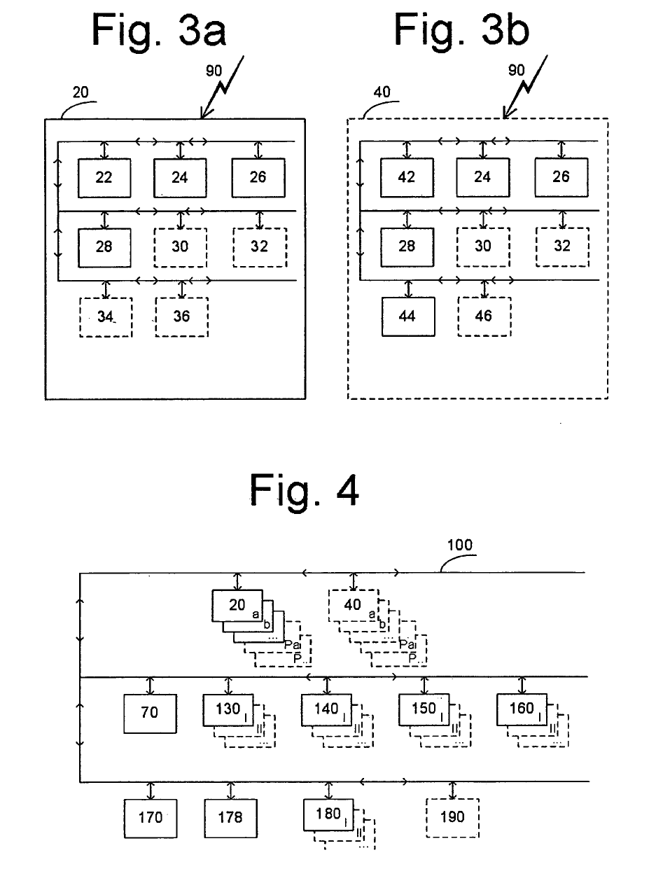

FIGS. 3a and 3b are exploded schematic diagrams of the automatic and the manual control points correspondingly of the present invention;

FIG. 4 is an exploded schematic diagram of a the communication network of the present invention;

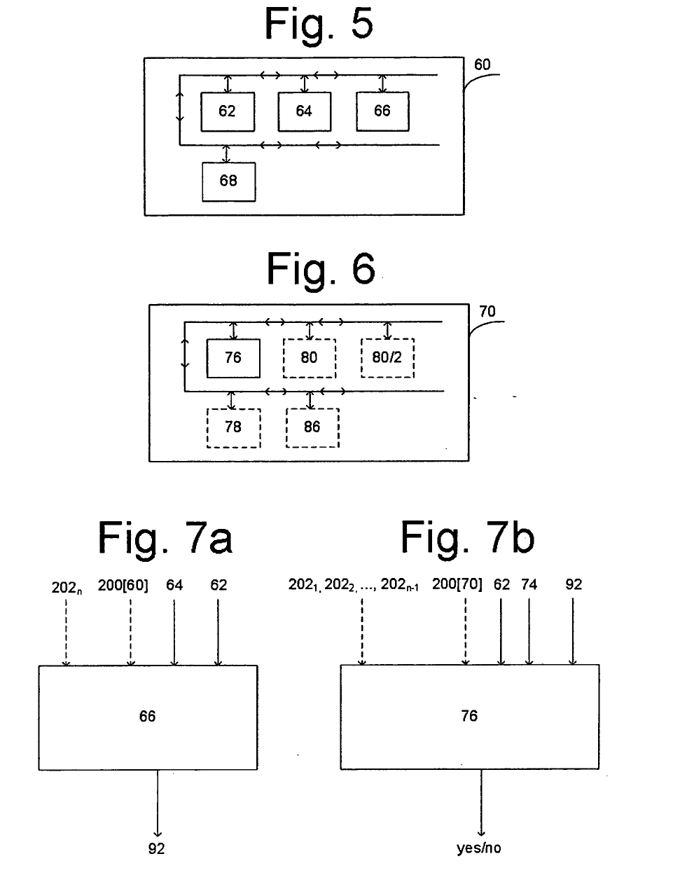

FIG. 5 is an exploded schematic diagram of the active license of the present invention;

FIG. 6 is an exploded schematic diagram of the means of authentication of the present invention;

FIGS. 7a and 7b are schematic diagrams of the inputs and the outputs of the cryptographic confirmation and validation algorithms in the active license and in the means of authentication of the present invention correspondingly;

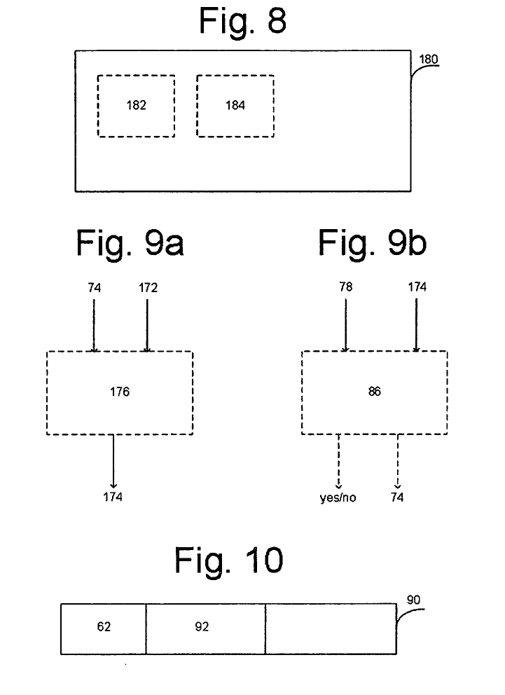

FIG. 8 is an exploded schematic diagram of the database of the present invention;

FIGS. 9a and 9b are schematic diagrams of the inputs and the outputs of the cryptographic binding and extraction algorithms in the means of issuing and in the means of authentication of the present invention correspondingly;

FIG. 10 is an exploded schematic diagram of the vehicle communication unit response of the present invention;

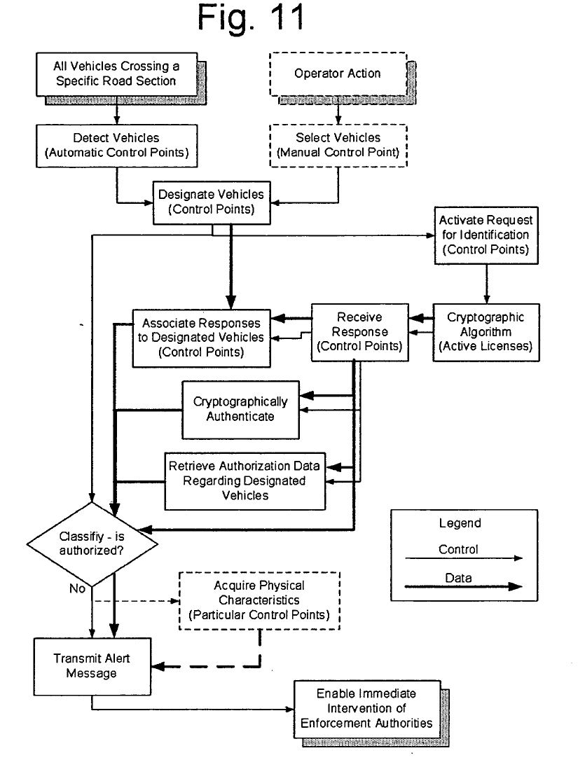

FIG. 11 is an example of a sequence of steps for the detection and/or control of unauthorized vehicles, among a large number of authorized vehicles according to the invention;

Authorized vehicles (12a, 12b, . . . ), and some unauthorized vehicles (10a, 10b, . . . ) are scattered in a controlled geographical zone (2) comprising a network of roads (4), the authorized and unauthorized vehicles being stationary and/or moving, and all authorized vehicles being provided with vehicle communication units (50a, 50b, . . . ).

Automatic control points (20a, 20b, . . . , 20Pa, . . . ) are placed at several road sections (21a, 21b, . . . ), and enforcement authorities patrol units are equipped with manual control points (40a, 40b, . . . , 40Pa, . . . ), these manual control points being either stationary of moving.

The automatic control points include components mounted for example on a frame with a horizontal beam supported above the carriageway, perpendicular to the direction of the traffic.

Each automatic control point comprises means (22) of detection of all vehicles crossing the specific road section (21) in its vicinity, the detected vehicles hereafter referred to as “designated vehicles”, each automatic control point additionally comprising means (24) of activating requests for identification to the designated vehicles, means (26) of reception, capable of receiving vehicle communication unit responses (90) to requests for identification, and a controller (28) capable of associating these vehicle communication unit responses to designated vehicles, some of the automatic control points comprising moreover means (30) of acquiring physical characteristics of the designated vehicles, allowing their direct recognition. In a first example of implementation, the means (22,24,26,28,30) are planned to operate without requiring a change in the motion conditions of the vehicles crossing the specific road section (21), in particular their velocity. In a second example of implementation, the means (22,24,26,28,30) are planned to operate requiring a non-substantial change in the velocity of the designated vehicles in the range of 0.5×V-1.5×V, V being the average velocity of the designated vehicles before reaching the specific section (21) in the vicinity of said automatic control points.

The means (22) of detection can be made by any known technique of vehicle detection such as magnetic sensing loops under the carriageway, optical or ultrasonic sensors, etc.

A first example of implementation of means (24), includes a transmitter in the automatic control point which sends to designated vehicles an electromagnetic wave through a directive antenna, carrying a request for identification message, this wave being typically in the frequency range of 10 Mhz-100 Ghz, preferably between 100 Mhz-2.5 Ghz, the vehicle communication units comprising means (52) of activating the transmission of an identification message, for instance a receiver operating in the same frequencies and a receiver controller analyzing said message.

A second example of implementation of means (24), includes a trigger element in the vicinity of the control points that are detectable by means (52) of the vehicle communication units, said trigger element being for instance a magnet or a loop supplied with a current, generating a magnetic field, means (52) being in this case a sensor comprising an element which responds to magnetic fields by a change of a current or a voltage, for instance a Hall effect detector, an inductive loop, a transformer, etc, and a sensor controller analyzing said change.

A first example of implementation of means (30) includes a digital camera. This implementation can produce compressed vehicle images, and/or be used in conjunction with an optical character recognition (OCR) mechanism to produce license plate identification.

A second example of implementation of means (30) is an automatic vehicle type recognition mechanism which consists of analyzing a digital image produced by a digital camera, possibly in conjunction with other gathering means such as sensors in the road measuring the vehicle weight, the number of axes, the distance between axes, etc.

The vehicles detected by means (22), the vehicles which received a request for identification from means (24), the vehicles which transmitted the vehicle communication unit responses received by means (26), and the vehicles whose physical characteristics were acquired by means (30), are each associated with geometric parameters related to the road section (21), and to the means (22,24,26,30) in the control point.

In an example of implementation, the geometric parameters include the relative location inside the specific road section of the detected vehicle, the coverage area of the antenna that receives the vehicle communication unit response, and the vehicle's velocity. The choice of these geometric parameters can be made by any known technique, for instance as commonly used in Electronic Toll Collection systems.

The controller (28) is capable of processing said geometric parameters in order to control the operation of means (24,26,30), and associate the data collected by means (26,30) with vehicles detected by means (22). Examples of associating transmissions received from vehicles and acquired vehicle physical characteristics with detected vehicles by processing geometric parameters can be found in the field of Electronic Toll Collection.

In an example of exploitation of the geometric parameters, the geometric parameters reported by the means (22) of detection regarding a particular detected vehicle, are used by the controller (28) in order to adjust the angle of a directive antenna of means (24), and adjust the focus distance of a camera in means (30). In addition, the geometric parameters reported by the means (26) of reception and the means (22) of detection are processed by the controller (28) in order to associate the received vehicle communication unit response with a detected vehicle.

In some cases, it may be beneficial to place the automatic control points so that they are concealed and/or easily and quickly transferable from one road section to another.

The vehicle communication unit is a self-contained device comprising an attachment means, which can be mounted for example on the windshield of the vehicle.

The vehicle communication unit additionally comprises a transmitter (54), and an active license. The active license is planned to contain the distinct identity, a communication port (68) intended for initialization and maintenance of data kept in the active license, particularly the secret cryptographic key, and to perform a cryptographic confirmation algorithm involving the secret cryptographic key, for example to encrypt with the secret cryptographic key a field consisting of the distinct identity and a checksum.

In a first example of implementation, the active license is an integrated circuit comprising a processor executing a program residing in memory, the cryptographic confirmation algorithm being for instance part of said program, or implemented in dedicated hardware circuitry, the distinct identity and secret cryptographic key being also stored in memory.

In a second example of implementation, the active license is a smart-card which has the same capabilities as the above described electronic card, implemented in a single integrated circuit, embedded for instance in a plastic support of a given standard size.

The transmitter (54) sends to the control points an electromagnetic wave carrying a vehicle communication unit response, this response consisting for example of a field containing the distinct identity and a crypto-bits field (92) containing the result of the cryptographic confirmation algorithm, the transmitter being made by any known technique, and the electro-magnetic wave being typically in the frequency range of 10 Mhz-100 Ghz, preferably between 100 Mhz-2.5 Ghz. The means (26) of reception in the control points receive the response through for example a directive antenna, operating in the same frequencies as the transmitter (54), and analyze this vehicle communication unit response.

Each manual control point comprises means (42) of selection of vehicles by an action of an operator, the selected vehicles also referred to hereafter as “designated vehicles”, each manual control point additionally comprising means (24) of activating a request for identification to the designated vehicles, means (26) of reception, capable of receiving vehicle communication unit responses to requests for identification, a controller (28) capable of associating said responses to said designated vehicles, and means (44) of notifying the manual control point operator, some of the manual control points comprising moreover means (30) of acquiring physical characteristics of the designated vehicles. In a first example of implementation, the means (24,26,28,30,42,44) are planned to operate without requiring a change in the motion conditions of the selected vehicles, in particular their velocity. In a second example of implementation, the means (24,26,28,30,42,44) are planned to operate requiring a non-substantial change in the velocity of the designated vehicles in the range of 0.5×V-1.5×V, V being the average velocity of the designated vehicles before reaching the specific section (21) in the vicinity of said manual control points.

Means (24,26) in the manual control points, are similar to their corresponding means in the automatic control points, particularly operating in the same frequency range since they both interact with the vehicle communication units in the vehicles. Of course, they may use different components than those used in the automatic control points, for instance in order to make the manual control points portable.

The means (42) of selection are for example a button pressed by the manual control point operator, upon for example directing an aiming device at a particular vehicle.

The vehicles selected by means (42), the vehicles which received a request for identification from means (24), the vehicles which transmitted the vehicle communication unit responses received by means (26), and the vehicles whose physical characteristics were acquired by means (30), are each associated with geometric parameters related to the aiming device position, and to the means (42,24,26,30) in the manual control point.

In an example of implementation, the geometric parameters include the relative location of the designated vehicle with respect to the manual control point and the vehicle's velocity. The choice of these geometric parameters can be made by any known technique, for instance as used in electronic ticketing systems or in car rental return parking.

The geometric parameters of means (42,24,26,30) are designed to ensure that, given proper aiming by the operator, sufficient geometric data is acquired to enable the controller (28) to distinguish the response or the lack of response of the selected vehicle from responses possibly received from other vehicles.

Some of the various system components described herein, such as the control points, are distributed throughout the controlled geographical zone, while others, such as the operations centers, may be located at any location inside or outside the controlled geographical zone. The communication network interconnects the various components, specifically the control points, the database (180), the means of issuing (170) and revoking (178) of vehicle licenses, the means (70) of authentication, the means of retrieving prior data (130), the means of classification (140), the means of alert (150) and the operations centers.

As for the means (70) of authentication, in an example of implementation, the means (70) of authentication comprise the validation key list containing the validation keys of all the active licenses and the distinct identities pointing to them, and are additionally planned, upon receiving a vehicle communication unit response, to utilize the distinct identity extracted from the vehicle communication unit response as an index to the validation key list, pointing to the corresponding validation key, this validation key being then used by the cryptographic validation algorithm to check whether or not the corresponding secret cryptographic key is the one which was used by the cryptographic confirmation algorithm in the generation of the received crypto-bits field, the cryptographic validation algorithm consisting for example of the decryption of the crypto-bits field.

In a first example of layout of the communication network, the means (70) of authentication, the means (130) of retrieving prior data, the means (140) of classification, and the means (150) of alert are incorporated inside the control points, and a global domain (a “Wide Area Network” WAN) interconnects all the control points with the means (170) of issuing, the means (178) of revoking, the database (180), and the operations centers.

In a second example of layout of the communication network, the means (70, 130, 140 and 150) are not incorporated inside the control points, but are rather part of the described Wide Area Network. Any of means (70,130,140,150,160,170,178,180) can be implemented in a distributed manner at different locations connected by the communication network.

Several well-known types of communication channels can be used to implement the WAN. One example is multiple point-to-point directional RF links, and a second example is ISDN over dedicated or leased copper wires.

In an example of the initialization process of issuing an active license to a newly authorized vehicle, the means of issuing (170) allocate a distinct identity unique to the active license or shared by a group, generate a secret cryptographic key unique to the distinct identity or shared by a group, calculate a corresponding validation key, initialize a new active license that bears the allocated distinct identity and the secret cryptographic key, update, via the communication network, the means (70) of authentication with the new distinct identity and validation key, equip the newly authorized vehicle's vehicle communication unit with the new active license, and update the database (180) with information regarding the newly authorized vehicle, such as license plate number, vehicle type and color, etc., particularly updating the authorized vehicle list.

A first example of implementation of means of issuing (170), well adapted to the described first example of implementation of the active license, includes a PC connected by a cable and an adapter to the communication port in the active license, communicating via a communication protocol, for instance a USB protocol, a serial communication protocol, an Ethernet protocol, etc.

A second example of implementation of means (170), well adapted to the described second example of implementation of the active license, includes a PC connected to a smart-card reader, in which the active license (being in this case a smart-card) is inserted, communicating via a smart-card communication protocol, for instance via ISO 7816/1-4 protocols.

The cryptographic process comprising the confirmation and validation algorithms is primarily provided for the purpose of verifying the authenticity of the active license in the vehicle communication units.

In a first example of implementation of this cryptographic process, the secret and validation cryptographic keys (64,74) are of a symmetric type (“symmetric key infrastructure”—SKI for those skilled in the art).

In a second example of implementation, the secret and validation cryptographic keys (64,74) are of an asymmetric type (“Asymmetric key infrastructure”, hereafter referred to as AsKI), utilizing “public key cryptography”, “elliptic curve cryptography”, etc.

It can be noted that in some cases it can be advantageous to use a combination of both types (SKI and AsKI).

One advantage of SKI is that it enables a strong cryptographic protection at a given length of the vehicle communication unit response, by allowing a longer key.

One advantage of AsKI is that the validation keys (i.e. the public keys) stored in the means (70) of authentication do not have to be kept secret, which can reduce to some extent the level of physical protection required for the means (70) of authentication.

The number of distinct identities sharing each secret cryptographic key and validation key being determined according to the level of security required for the vehicles bearing those distinct identities, thus balancing the implementation complexity with the security requirements.

It can be noted that it can also be additionally advantageous to issue each active license with multiple secret cryptographic keys, each belonging to a different key set, providing the means (70) of authentication with only a single set of validation keys at a given time, and the control points indicating as part of the request for identification, which of the keys in the active license to use. When it is desired to switch to the next key set, the entire validation key set in the means (70) of authentication is replaced, and the key selection indications in all the requests for identification are changed correspondingly to select the key belonging to the new set.

In a particular variant of the above described initialization process based on AsKI, the means of issuing (170) require the active license to generate the secret cryptographic key and calculate the corresponding validation key, the means of issuing (170) further reading the validation key from the active license, the rest of the above described initialization process unchanged, the described variant being especially advantageous since the secret cryptographic key (i.e. the private key) is generated by the active license and never leaves the active license, thereby reducing the exposure of the secret key to a minimum.

Several active license arrangements may be advantageous in preventing perpetrator attempts to gain access to the secret cryptographic key contained within.

One such arrangement involves placing the memory, which contains the secret cryptographic key on a removable support, thus avoiding leaving the secret cryptographic key in an unattended vehicle where it is exposed to theft attacks.

Another such arrangement involves placing the memory, which contains the secret cryptographic key on an anti-tamper support preventing a perpetrator from finding out, through physical penetration and/or deduction, the secret cryptographic key.

Yet another such arrangement involves placing the memory, which contains the secret cryptographic key on a displacement-proof support, which is physically attached to the vehicle, in a manner preventing its intact physical displacement from the vehicle. Said support would be planned in a manner that an attempt to displace it from the vehicle, would result in its destruction, and/or the elimination of the secret cryptographic key from this memory.

Still another such arrangement involves placing the memory, which contains the secret cryptographic key and the processor which performs the cryptographic confirmation algorithm, inside a support, in a manner that the secret cryptographic key and all the information produced while performing the cryptographic confirmation algorithm, leading to a possible disclosure of the secret cryptographic key, never leave said support, except for possibly during the initialization process of the active license, being particularly advantageous when said support is additionally planned in accordance with the characteristics of the support described in any of the above three arrangements.

A technology commonly used for implementing a protective support containing memory and processing capabilities, often used in security related applications, is smart-card technology, in which case the active license is a tamper-proof smart card, containing both the secret cryptographic key and the entire implementation cryptographic confirmation algorithm, and can additionally be either removable, providing the active license with a smart card reader, or displacement-proof, in which case the smart card is fixed to the vehicle in a difficult to access location, and is designed to break in a critical location, rendering it dysfunctional, when subject to a displacement attempt.

Other examples of technologies for implementing a protective support containing memory and processing capabilities, are PCMCIA cards, or USB tokens.

Several enhancements to the cryptographic process may be advantageous in preventing perpetrator attempts to impersonate an active license by recording and replaying a vehicle communication unit response of an active license of a vehicle communication unit of an authorized vehicle, hereafter referred to as replayed response. This can be achieved by planning the cryptographic algorithms (66,76) of the active license and the means (70) of authentication, in a way that transmitting a replayed response to a request for identification, in response to another request for identification would result in an authentication failure, typically by planning the results of the cryptographic confirmation algorithm of the active license of an authorized vehicle to be different at different times.

A first example of a replay prevention technique is by providing both the active licenses of authorized vehicles and the means (70) of authentication with the capability to acquire the same digital element (200) of a first type, which is different at different times, the digital element of the first type acquired by the active licenses denoted (200[60]), and the digital element of the first type acquired by the means (70) of authentication denoted (200[70]). The digital element (200[60]) is involved in the cryptographic confirmation algorithm of the active license, and thus affects the crypto-bits field, the means (70) of authentication being additionally planned to compare digital element (200[60]), extracted from the crypto-bits field, with the digital element (200[70]), a positive comparison result being also additionally required for the successful authentication of the vehicle communication unit response.

An example of involving the digital element (200[60]) of the first type in the cryptographic confirmation algorithm can be by additionally encrypting the digital element (200[60]) with the secret cryptographic key, the extraction of the digital element (200[60]) from the crypto-bits field being accomplished in this case by decrypting the crypto-bits field with the validation key.

A first example of implementation of this technique is creating the digital element (200[60], 200[70]) both in the active license and in the means (70) of authentication using separate clocks planned to provide a similar time reading.

A second example of implementation of this technique is generating a digital element (200) by any means connected to the communication network (e.g. the control points), transferring it to the means (70) of authentication (digital element (200[70])) through the communication network, and transmitting it to the active license (digital element (200[60])) as a part of the identification request.

A third example of implementation of this technique is to supply all the active licenses and the means (70) of authentication with a predefined series. Each active license additionally contains an index A to this series. As a result of an identification request, the active license uses the element in the series pointed to by the index A as the digital element (200[60]), and increments the index A. The means (70) of authentication contain a separate index B for each distinct identity, the cryptographic validation algorithm being planned to check whether the digital element (200[60]) extracted from the crypto-bits field, exists in the predefined series, with an index greater than index B corresponding to the distinct identity extracted from the vehicle communication unit response. If such an element exists, it is regarded as digital element (200[70]), and index B is updated to be identical to index A.

A second example of a replay prevention technique is by providing each active license the capability to generate a digital element of a second type, either randomly and/or deterministically, which is different at different times (202₁, 202₂, . . . ), the digital element (202ₙ) being involved in the cryptographic confirmation algorithm of the active license, and thus affecting the crypto-bits field. The means (70) of authentication are additionally planned to extract the digital element (202ₙ) from the received crypto-bits field, for example by decrypting the crypto-bits field, accumulate the extracted digital elements associated with each distinct identity, and compare the extracted digital element (202ₙ), with all the previously extracted and accumulated digital elements (202₁, 202₂, . . . , 202ₙ₋₁) associated with the distinct identity extracted from the vehicle communication unit response. If the received digital element is found in the accumulated list, it is regarded as a replay attempt, and therefore the vehicle communication unit response is not authenticated.

In another vehicle communication unit arrangement of particular interest, it may be advantageous to prevent a perpetrator from utilizing a stolen authorized vehicle, vehicle communication unit, or active license, to impersonate an authorized vehicle.

In this arrangement, the initialization process of each active license is enhanced in a way that the means (170) of issuing additionally supply a PIN to the user in possession of the authorized vehicle to which the active license is issued. The driver of an authorized vehicle is requested to enter the PIN to the active license by a keyboard in the vehicle communication unit, at predefined events, such as upon ignition, the entered PIN being typically stored in volatile memory within the active license, and erased upon occurrence of a predefined event such as turning off the ignition.

In a first example of this arrangement, the entered PIN is additionally involved in the cryptographic confirmation algorithm, for example by additionally encrypting the entered PIN with the secret cryptographic key, the means (170) of issuing additionally supplying in this case the PIN to the means (70) of authentication during the initialization process, and the means (70) of authentication also additionally utilizing the distinct identity as an index to a list pointing to the corresponding PIN, enabling the means (70) of authentication to check through the cryptographic validation algorithm whether or not the same PIN is the one used by the cryptographic confirmation algorithm in the generation of the received crypto-bits field.

In a second example of this arrangement, the PIN is additionally supplied to the active license by the means (170) of issuing during the initialization process, the active license requiring the PIN supplied by the user to be equal to the PIN supplied during the initialization process, in order to enable the generation of the vehicle communication unit response.

In all cases, the cryptography embedded in the invention severely limits the threat raised by perpetrators, even if they are well equipped.

The above-described implementation of the invention can be modified in a manner eliminating the need to update the means (70) of authentication with each newly authorized vehicle, this modification, described hereafter, being referred to as indirect validation system.

In an indirect validation system, the means (70) of authentication do not contain the validation key list, but are rather planned to securely extract the validation key from a credential (174) received as an additional part of each vehicle communication unit response, utilizing the extraction key (78) and the cryptographic extraction algorithm (86), the extracted validation key being used in a similar manner as in the above-described implementation of the invention.

The active license is additionally planned to incorporate the credential into the vehicle communication unit response, for example as an appended additional field.

For each newly authorized vehicle, the means (170) of issuing are planned to additionally initialize the new active license with the credential, which is calculated by utilizing a binding key (172), the validation key of the initialized active license and a cryptographic binding algorithm (176), as part of the initialization process.

In a first example of implementation of an indirect validation system, the credential comprises an encryption of the validation key performed utilizing the binding key and the cryptographic binding algorithm. In this case, the means (70) of authentication accomplish the secure extraction of the validation key by decrypting the credential, utilizing the extraction key and the cryptographic extraction algorithm.

In a second example of implementation of an indirect validation system, the credential comprises a field containing the validation key and a field containing the result of the cryptographic binding algorithm on the validation key, utilizing the binding key, in which case the means (70) of authentication additionally verify that the binding key was the one used in the generation of the credential, by utilizing the extraction key and the cryptographic extraction algorithm, this verification being additionally required in order to successfully authenticate the vehicle communication unit response.

In a first example of implementation of the credential and the secure extraction of the validation key from it, the cryptographic keys (78, 172) are of a symmetric type, while in a second example, the cryptographic keys (78, 172) are of an asymmetric type.

Several examples of implementation of the process of revoking active licenses of authorized vehicles will be now described in a non-limitative way.

A first example of active license revocation, is when an active license, is valid for a predetermined limited period of time, this period expiring without action being taken to renew the validity of the active license. In such a case the means (178) of revoking automatically update the database (180) to indicate that the vehicle whose authorization has expired is unauthorized.

A second example of active license revocation is when an enforcement authority initiates the revocation of a vehicle's authorization, as a result either of information regarding illegal usage of the vehicle (such as vehicle theft, participation in an act of crime, etc. . . . ) or on information regarding the safety condition of the vehicle (old age, no technical inspection made in due time, etc). In such a case the means (178) of revoking update the database (180) to indicate that the vehicle is unauthorized according to the enforcement authorities initiated revocation.

In both above examples, the implementation of active license revocation can be made by deleting the vehicle communication unit active license's distinct identity from the authorized vehicle list and/or adding the vehicle communication unit active license's distinct identity to the unauthorized vehicle list.

It can be noted, that the means (178) of revoking could also provide a possibility for restoring the status of an authorized vehicle to formerly revoked vehicles.

As for the database (180), in a first example of implementation, the database (180) comprises a list of distinct identities of active licenses in authorized vehicles' vehicle communication units, hereafter referred to as authorized vehicle list, indicating as unauthorized vehicles that do not appear in the authorized vehicle list.

As for the database (180), in a second example of implementation, the database (180) comprises a list of distinct identities of active licenses in unauthorized vehicles' vehicle communication units, hereafter referred to as unauthorized vehicle list, indicating as unauthorized vehicles that appear in the unauthorized vehicle list.

As for the database (180), in a third example of implementation, the database (180) comprises a list of distinct identities of all the active licenses, and corresponding expiration dates, indicating as unauthorized vehicles whose active license's expiration date has passed.

Numerous well known technologies can be used in order to implement the invention. An example of implementation of the communication channel carrying the vehicle communication unit response will now be described in a non-limitative way, taking into account the possible speed of the vehicles and the geometry of the road and the control points.

For instance, the vehicle communication unit response can be comprised of the following fields: a bit and frame synchronization field SYNC of a nominal size of [32] bits, typically in the range of [16-64] bits, a distinct identity field of nominal size [32] bits, typically in the range of [16-48] bits, a crypto-bits field of nominal size [128] bits, typically in the range of [64-256] bits, which could be for example the output of any known block cipher, for example 3DES, encrypting a buffer comprised of the concatenation of the time of day TOD and the distinct identity, an error correction field ECC on both the distinct identity and crypto-bits fields, with a nominal rate ⅓, typically in the range of [¼-¾], all this amounting to a nominal total message size of [512] bits, typically in the range of [256-1024] bits. Taking into account the need for an anti-collisions protocol which serves as a MAC layer, such as CD/CSMA or ALOHA protocols, typically combining multiple channels and/or sensing the channel and/or randomness, may double this figure to a nominal effective message size of [1024] bits, typically in the range of [512-2048] bits.

In such a typical implementation, the nominal RF carrier frequency could be around [120 MHz], although there is a wide range of adequate carrier frequencies suitable for this purpose [2 MHz-100 GHz], the nominal frequency band allocated to a channel would be [100 KHz], typically in the range of [10 KHz-1 MHz], the nominal spectral efficiency of [½ Bit/(Hz*sec)], typically in the range of [¼-8 Bit/Hz], all this amounting to a nominal transmission time of the vehicle communication unit response of [1024/(100 khz*½ bit/(hz*sec)=20 msec], typically in the range of [1-200 msec].

In such a typical implementation, the means (24) of activating a request for identification is a trigger element that is sensed by the vehicle communication unit, within a [½ m] bounded geometric region within the road section (21). Upon sensing the trigger element by means (52), the vehicle communication unit requests the active license to prepare the vehicle communication unit response, which nominally takes [2 msec], typically in the range of [1 μs-50 ms], comprised mostly of the 3DES calculation.

In such a typical implementation, the means (70) of authentication are implemented in the control point, as described above. Upon receiving the vehicle communication unit response, the means (70) inside the control point verify the crypto-bits field, nominally taking [2 msec], typically in the range of [1 μs-50 ms], the means (130) of retrieving prior data also residing inside the control point, operate in parallel to means (70), also nominally taking [2 msec], typically in the range of [1 μs-50 ms], the means (140) of classification also residing inside the control point, nominally taking [1 msec], typically in the range of [1 μs-50 ms], to decide whether this designated vehicle is authorized or not. Upon a decision that a designated vehicle is unauthorized, the means (140) of classification request the controller (28) to operate means (30) in order to acquire physical characteristics of this vehicle, nominally requiring [25 msec] (e.g. a photo or a video camera), typically in the range of [10-100 msec].

Even for a perpetrator driving at a speed of [240 km/hour] ([66.6 m/s]), summing up the time periods described above results in a duration of [20+2+1+25˜50 msec], which corresponds to [3.3 m]. Adding the [0.5 m] required by means (24) results in a [3.8 m] vehicle advancement distance from activating a request for identification to acquiring the physical characteristics of an unauthorized vehicle. Assuming that vehicle detection is carried out parallel to activating the request of vehicle identification, this distance is the upper limit to the advancement of a vehicle during the entire interaction between the automatic control point and a designated vehicle.

In such a typical implementation, means (24) are planned at a distance of [20 m] from the antenna of means (26), typically at a distance of [1-100 m]. In such a case, the transmission power of the vehicle should allow for reliable RF communications for a nominal distance of [50 m], typically in the range of [10-100 m], in which case a nominal RF transmission power of [100 mwat] can be used—as in other known roadside to vehicle communication systems, although RF transmission power in the range of [1 mwat-1 wat] can also be suitable.

In many cases, it may be advantageous for the automatic control points to be capable of performing an automatic interrogation process, upon all vehicles passing through a multi-lane road section of free flowing vehicle traffic. A wide variety of vehicle types (cars, motorcycles, trucks, etc) may be positioned anywhere within the controlled multi-lane road section, at any given time, with the possibility of multiple vehicles present within the controlled road section simultaneously. The control point according to the invention, needs to associate each of a number of responses simultaneously received by means (26) and each of a number of physical characteristics simultaneously acquired by means (30) with any of a number of vehicles simultaneously detected by means (22). Means (22, 24, 26, 30) are planned to perform geometrically discernable interaction with a number of vehicles simultaneously, the controller (28) handling the interaction between the different means. Systems with the capability to associate vehicle responses and acquire physical characteristics to detect vehicles under conditions as described above are well known, for instance in the domain of Electronic Toll Collection Systems.

### EXAMPLE OF AN AUTHORIZED VEHICLE PASSING THROUGH AN AUTOMATIC CONTROL POINT

An example of implementation of the process, which occurs upon the passage of an authorized vehicle through the road section monitored by an automatic control point, shall now be described, this particular process being hereafter referred to as automatic interrogation.

When a vehicle enters the specific road section, means (22) detect its presence and report it to the controller (28), the latter requiring means (24) to activate a request for identification to the designated vehicle.

Consequently, means (52) in the vehicle communication unit of the authorized vehicle request the active license to perform the cryptographic confirmation algorithm (66), utilizing the secret cryptographic key, the constructed vehicle communication unit response consisting of a field containing the distinct identity and the crypto-bits field, means (54) consequently transmitting the response to means (26) in the automatic control point.

In one particular variant, the active license performs said cryptographic confirmation algorithm regardless of any request for identification by the control points, the request for identification in this case causing the result of the cryptographic confirmation algorithm already stored in the active license memory, to be included in the vehicle communication unit response.

The distinct identity of the active license is determined from the distinct identity field in the vehicle communication unit response, and is then sent by the means (26) of reception to the controller (28), to the means (70) of authentication, to the means of retrieving prior data (130), and to the means of classification (140), the crypto-bits field being additionally sent to the means of authentication (70).

The controller (28) associates the received vehicle communication unit response with the designated vehicle, and sends the result to the means of classification (140).

In an example of the process of cryptographically authenticating the vehicle communication unit response, upon receiving said crypto-bits field and the distinct identity field, the means (70) of authentication utilize the distinct identity as an index to the validation key list, pointing to the corresponding validation key, this validation key being then used by the cryptographic validation algorithm to decrypt the crypto-bits field, and check whether or not the corresponding secret cryptographic key is the one which was used by the cryptographic confirmation algorithm in the generation of the received crypto-bits field.

The result of the above authentication process is sent to the means (140) of classification.

In a particular variant of the described authentication process, in which SKI is used, the cryptographic validation algorithm is a duplicate of the cryptographic confirmation algorithm, creating a crypto-bits field utilizing the distinct identity and validation key, the created crypto-bits field being compared to the received crypto-bits field, and check whether or not the resulting fields are matching.

The means (130) of retrieving prior data utilize the distinct identity to retrieve from the database (180) authorization data regarding the vehicle bearing this distinct identity, particularly, to check whether or not the active license of the designated vehicle was revoked, sending the result to the means (140) of classification.

The means of classification (140) utilize the data produced by the means (22) of detection and/or the means of reception (26) and/or the controller (28), and/or the means of authentication (70) and/or the means of retrieving prior data (130) to determine whether the designated vehicle is authorized or not.

Since in the above example the designated vehicle is authorized, the controller (28) successfully associates the response to the designated vehicle, the means (70) of authentication successfully authenticate the vehicle communication unit response, the authorization data retrieved regarding the designated vehicle do not indicate that it is unauthorized, all of which being required to classify the vehicle as authorized.

### EXAMPLES OF UNAUTHORIZED VEHICLES PASSING THROUGH AN AUTOMATIC CONTROL POINT

Some of the advantages of the invention will now be clearly visible, by considering, in a non-limitative way, four examples of unauthorized vehicles passing through road sections monitored by automatic control points.

### Example 1

A vehicle which has never undergone the authorization process and thus is not equipped with a vehicle communication unit, for example if having been smuggled into the controlled geographical zone, does not respond to the request for identification message, and thus the controller (28) fails to associate any vehicle communication unit response with the designated vehicle, and the means (140) of classification consequently classify the vehicle as unauthorized.

### Example 2

A previously authorized vehicle which has been reported as stolen, appears in the database (180) as unauthorized, as a result of the enforcement authorities action through the means (178) of revoking, and thus the means (130) of retrieving prior data will report to the means (140) of classification that the designated vehicle is unauthorized, and the means (140) of classification consequently classify the vehicle as unauthorized.

### Example 3

A previously authorized vehicle whose vehicle communication unit was disabled by a perpetrator in an attempt to avoid being apprehended as a result of the vehicle being reported as stolen, does not respond to the request for identification message, and thus the controller (28) fails to associate any vehicle communication unit response with the designated vehicle, and the means (140) of classification consequently classify the vehicle as unauthorized.

### Example 4

In an unauthorized vehicle in which the vehicle communication unit has been imitated by a perpetrator, but not the active license, because of its' cryptographic protection, as described above, the means (70) of authentication fail to authenticate the vehicle communication unit response, and thus the means (140) of classification consequently classify the vehicle as unauthorized.

In any of the cases in which the designated vehicle is classified as unauthorized, the means (140) of classification activate the means (150) of alert, which transmit an alert message regarding the unauthorized vehicle, to an operations center, the alert message containing the control point identity, the vehicle designation time and any part of the information collected regarding the vehicle which may be advantageous to the interception of the unauthorized vehicle by the enforcement authorities. In the particular automatic control points (20Pa, 20Pb, . . . ), additional information acquired by means (30), such as photographic information, license plate number, etc, is included in the alert message.

It can be noted that the operation of means (30) of acquiring physical characteristics can be unaffected by the classification result (i.e. means (30) operate for every designated vehicle). In this case, the conditioning of the alert message on the classification result, as well as the inclusion of said acquired physical characteristics in said alert message remain the same as in automatic interrogation. The physical characteristics data regarding vehicles classified as authorized, may either be accumulated or discarded.

It can be noted that it may be advantageous to additionally prioritize the alert messages according to the control point characteristics, such as its location (e.g. proximity to a border), alert message history (e.g. RF problems in the vicinity), etc. . . . , and/or the time of designation of the vehicle (e.g. at night vs. daytime), and/or the said acquired physical characteristics if available (e.g. a vehicle with excessive weight), and/or current operational intelligence if available (e.g. concrete information regarding criminal activity in the area), in order to improve the effectiveness of the intervention of the enforcement authorities.

The means (32) of sending a notification in the control points can selectively transmit to vehicles classified as unauthorized a message, this message being consequently received and brought to the attention of the driver by means (56) of notification in the vehicle communication unit. In such a way, the active assistance (e.g. calling a hotline) of law-abiding drivers, can help in diminishing the false-alarm rate of the system, and/or improve the capability to prioritize the handling of vehicles classified as unauthorized.

The invention not only allows for pinpointing the location of any unauthorized vehicle amongst the multitude of authorized vehicles unobstructively passing by any one the of automatic control points, but also provides the enforcement authorities with the capability to promptly intercept any of the unauthorized vehicles, by providing sufficient real-time information in order to allow the direct recognition of these vehicles.

### EXAMPLE OF AN AUTHORIZED VEHICLE SELECTED BY A MANUAL CONTROL POINT

An example of implementation of the process, which occurs as a result of the selection of an authorized vehicle by an enforcement authority official operating a manual control point, shall now be described, this particular process hereafter referred to as manual interrogation.

When an enforcement authority official (the operator) decides to examine the status of a particular vehicle, moving, stationary or parked, he performs the selection of this vehicle utilizing means (42), in compliance with the mobile control point's vehicle selection geometric envelope (range, angle, etc). Means (42) consequently report the vehicle designation to the controller (28), the latter requesting means (24) to activate a request for identification to the designated vehicle, similar to that activated by automatic control points to designated vehicles. The consequent behavior of the vehicle communication unit, therefore, is identical to that of a vehicle communication unit triggered by an automatic control point, generating the transmission of a vehicle communication unit response consequently received by means (26) in the manual control point. The distinct identity and crypto-bits fields extracted from the vehicle communication unit response are dispatched to the relevant means in a similar manner to that of the automatic control point.

The controller (28) determines whether or not the vehicle communication unit response is received from the designated vehicle, and sends the result to the means (140) of classification.

The means (70) of authentication, the means (130) of retrieving prior data, and the means (140) of classification operate in the same manner as described for the automatic interrogation process.

It can be noted that the four previously described examples of unauthorized vehicles passing by automatic control points, can be directly applied to the case of manual control points, leading to the same classification results.

When the designated vehicle is classified as unauthorized, the means (140) of classification activate the means (150) of alert, which transmit an alert message to the operator by means (44), providing him with on-the-spot indication of whether the designated vehicle is authorized or not, and possibly with additional information regarding this vehicle, such as reason for classifying the vehicle as unauthorized, reason of revocation if applicable, etc.

Here also, a strong advantage of the invention results in that the manual control points provide enforcement authorities with an important complementary capability to selectively interrogate moving or stationary vehicles at any location in the controlled geographical zone, regardless of the automatic control points' dispersement throughout the controlled geographical zone, enabling an enforcement authority official to receive on-the-spot authorization status regarding any chosen vehicle, specifically any unauthorized vehicle, and respond immediately.

The invention is in no wise limited to the modes of embodiment which have been described here-above, it includes on the contrary all variants, and particularly those in which:

i) Each authorized vehicle is equipped with a second active license (60/2) containing the same distinct identity as the first active license (60) and a second secret cryptographic key (64/2), the first active license being non-removable and implemented for instance by a smartcard, and the second active license being removable and also implemented for instance by a smartcard, the second active license otherwise implemented similarly to the first active license, this variant being hereafter referred to as a dual vehicle license system.

The dual vehicle license system initialization process is similar to the initialization process described above with the following additions: the means (170) of issuing additionally generate a second secret cryptographic key, additionally calculates a second corresponding validation key (74/2), additionally initialize the second active license that bears the same allocated distinct identity of the first active license and the second secret cryptographic key, additionally update via the communication network, the means of authentication (70) with the second validation key, and additionally equip the newly authorized vehicle's vehicle communication unit with the second active license.

The dual vehicle license system vehicle communication unit response consists of for example an additional second crypto-bits field (92/2) corresponding to the second active license. When the removable smartcard is not present, its corresponding crypto-bits field contains a NIL value or similar indication.

The dual vehicle license system automatic interrogation, is similar to the automatic interrogation process described above, the means (26) of reception additionally sending the second crypto-bits field to the means (70) of authentication, and the means (70) of authentication, upon receiving both crypto-bits fields and the distinct identity field, additionally utilizing the distinct identity as an index to the second validation key list (80/2), pointing to the corresponding second validation key, this second validation key being then used by the cryptographic validation algorithm to decrypt the second crypto-bits field, and check whether or not the corresponding second secret cryptographic key was the one used by the cryptographic confirmation algorithm in the generation of the received second crypto-bits field, sending the result to the means (140) of classification. In case the removable smartcard inserted to the vehicle communication unit belongs to a second active license with a different distinct identity than that of the first non-removable active license, than the vehicle communication unit response will not be successfully authenticated, since the distinct identity field would point to a wrong validation key in either the first or second validation key lists (80, 80/2).

The dual vehicle license system manual interrogation is similar to the manual interrogation process described above, but has two interrogation sub-modes, the first referred to as partial interrogation mode and the second referred to as dual interrogation mode. Means (46) are provided to allow the operator of the manual control point to select between the two interrogation sub-modes. The partial interrogation mode is identical to manual interrogation described above, i.e. the means of authentication ignore the second crypto-bits field if it exists. The dual interrogation mode is similar to the manual interrogation described above, with the same enhancements described for the dual vehicle license system automatic interrogation.

In a variant of the dual vehicle license system the distinct identities of the first active licenses and second active licenses are independent. With this variant, hereafter called an integrated vehicle and driver license system, the second active license can be used as a driver's license. The integrated vehicle and driver license system, in addition to being an Unauthorized Vehicle Control solution, provides an equally advantageous solution to the difficult problem of unauthorized drivers.

It can be noted that the above variants bring even more advantages to the invention, since they prevent attacks by extremely skilled perpetrators in the case of parked or stolen vehicles, while enforcement authorities still have the possibility to interrogate, parked or unattended vehicles.

An example of the integrated vehicle and driver license system would be to use the second active license as a permit for special cargo (hazardous, valuable, etc), hereafter referred to as integrated vehicle and cargo license system. The manual interrogation sub-modes of the integrated vehicle and cargo license system are identical to those of the integrated vehicle and driver license system. The automatic control points can either be planned to always perform partial interrogation (i.e. the means of authentication ignore the second crypto-bits field if it exists), or perform dual interrogation of vehicles carrying special cargo, which requires that the automatic control points be additionally equipped with means (34) of special cargo detection, that automatically detect whether or not each designated vehicle carries a special cargo (excess weight sensors, excess dimensions sensors, etc).

ii) The database is additionally planned to record data regarding designated vehicles, such as distinct identities, control points characteristics (such as their location), times of designation of vehicles, etc, this data being collected by the control points as the result of the interrogation processes, and being further sent through the communication network to the database (180), this recorded data (186) being processed by an algorithm, which searches for inconsistencies with regard to time and/or vehicles location.

This variant is advantageous in assisting enforcement authorities in finding potential impersonations of active licenses. For example, a distinct identity, which was recorded as the result of two separate interrogation processes, at two control points that are 100 km apart, within a 10 minutes interval, indicates a potentially duplicated active license.

iii) The controlled geographical zone contains multiple geographical sub-zones, each vehicle being further authorized or unauthorized for each of the geographical sub-zones separately and independently, each sub-zone being further equipped with automatic control points and optionally with manual control points this enhancement hereafter referred to as multi-zone Unauthorized Vehicle Control system.

In order to achieve this, for each sub-zone, a separate database (180I, 180II, etc) of authorization data regarding said particular active license distinct identities, and separate means of retrieving prior data (130I, 130II, etc) are implemented. For each sub-zone, the corresponding means of retrieving prior data (130I, 130II, etc) are capable of retrieving vehicle authorization data from the corresponding database (180I, 180II, etc).

The interrogation process of each control point is enhanced in the following manner: the distinct identity field in the vehicle communication unit response is additionally sent by means (26) to the means of retrieving prior data (130) corresponding to each of the sub-zones to which this control point belongs, each of the means (130) of retrieving prior data also additionally utilizing this distinct identity to retrieve from the corresponding database (180) authorization data regarding the vehicle bearing this distinct identity, sending the result to the means (140) of classification.

The means (140) of classification additionally utilize the data produced by the means (130) of retrieving prior data of all the sub-zones to which the control point which designated this vehicle belongs, to determine whether the designated vehicle is authorized or not.

In an example of the multi-zone Unauthorized Vehicle Control system it may be advantageous to have separate means (140) of classification, separate means (150) of alert and a separate operations center for any group of sub-zones. In such a case, the means (70) of authentication send their result to all the means (140) of classification of all sub-zones to which the control point which designated this vehicle belongs, each of the means (140) of classification determining whether the designated vehicle is authorized or not separately and independently. In any of the cases in which the designated vehicle is classified as unauthorized by one of the means (140I, 140II, . . . ) of classification, that means (140) of classification activate the corresponding means (150) of alert, which transmit an alert message to the corresponding operations center, regarding this unauthorized vehicle.

The controller (28) and means (26) of reception of each automatic control point are configured upon installation with a list of all sub-zones to which it belongs, determining to which means (140) of classification the relevant data is to be dispatched. The sub-zone configuration of each manual control point can either be pre-configured and fixed, or configurable by the operator.

As already described in great detail, the invention solves the problem of Unauthorized Vehicle Control. It can be noted, that once such a method and/or system have been implemented, they can be simultaneously used to perform standard applications, however with improved characteristics, and among them:

i) Electronic Toll Collection. For this purpose, the capability of acquiring either the distinct identity or physical characteristics for every vehicle that passes through an automatic control point, is utilized by a means (190) of debiting connected to the automatic control point through the data network.

ii) Access Control, in particular on the perimeter of the controlled geographical zone and/or any of its sub-zones. For this purpose, a variation of the automatic control points is planned which additionally incorporates a physical barrier (36), the opening of this barrier being controlled according to the classification result.

iii) Vehicle Messaging. For this purpose the means (32) of sending a notification and the means (56) of notification are additionally planned to provide the driver with information provided by any additional means connected to the data network.

iv) Fleet Management and/or a statistical survey tool, and/or a crime investigation tool. For this purpose the data regarding the presence and time of presence of authorized vehicles in specific control points is transferred at real-time and/or offline through the data network to a means planned to perform fleet management and/or a statistical survey tool, and/or a crime investigation tool.

v) Traffic law enforcement. For this purpose the ability to acquire the distinct identity of a vehicle located within a geometrically bounded road section, is used in conjunction with other means of detecting traffic law violations committed by vehicles situated in the same geometric location, particularly, the means of detecting a traffic law violation detecting speed violations by dividing the distance between two control points by the time difference between the acquisitions of the same distinct identity at the two control points.

vi) data analysis. The invention allows to store additional data in the memory of the active license and possibly read this additional data as an additional part of the vehicle communication unit response and/or alter this additional data as a consequence of an instruction transmitted from the control point as an additional part of the request for identification. This makes it possible to apply well known data-mining technologies in the field of automotive systems, and/or social behavior of drivers for instance.

1. A security method for the detection and/or control of unauthorized vehicles (10a, 10b, . . . ) among a large number of authorized vehicles (12a, 12b, . . . ) within a controlled geographical zone (2), characterized in that all authorized vehicles are equipped with active licenses (60a, 60b, . . . ) planned to perform a cryptographic action involving a secret cryptographic key (64), and the controlled geographical zone is equipped with automatic control points (20a, 20b, . . . ), and optionally with manual control points (40a, 40b, . . . ), each automatic control point detecting all vehicles crossing a specific road section (21) in its vicinity, and each manual control point selecting vehicles by the action of an operator, the vehicles detected by the automatic control points and the vehicles selected by the manual control points being hereafter referred to as designated vehicles, both types of control points being planned to acquire the results of said cryptographic actions performed by the active licenses of said designated vehicles, a cryptographic authentication algorithm involving a validation key (74) being further performed upon each acquired said result, both types of control points being further planned to associate said acquired results to said designated vehicles, the designation of the vehicles, the acquiring of said results, and the performing of the cryptographic authentication algorithm upon said acquired results not requiring a change in the motion conditions of the vehicles, in particular their velocity, classifying as unauthorized at least vehicles which have been designated but whose said results either have not been acquired or have not been cryptographically authenticated, an alert message being transmitted to enforcement authorities for each vehicle which has been classified as unauthorized, allowing in such a way for an immediate intervention and a possible interception of the unauthorized vehicles, at least some of the control points, hereafter referred to as particular control points, being moreover planned to acquire physical characteristics of said designated vehicles, allowing their direct recognition, said alert message including in this case said physical characteristics.

2. A method as described in claim 1, in which at least some of said active licenses, hereafter referred to as particular active licenses, additionally have distinct identities (62a, 62b, . . . ), each distinct identity belonging to a group of one or more of said particular active licenses, and distinct identity determination being further performed for all designated vehicles bearing said particular active licenses, upon each said acquired result.

3. A method as described in claim 2, in which said controlled geographical zone contains one or more sub-zones, each vehicle being further authorized or unauthorized for each of the sub-zones, each sub-zone being further equipped with automatic control points and optionally with manual control points, a database (180) of authorization data regarding said particular active license distinct identities being associated with each sub-zone, each determined distinct identity of a vehicle designated by a control point being further checked against said authorization data in the databases associated with the sub-zones containing that control point, said databases being automatically and/or manually modifiable by the enforcement authorities, additionally classifying as unauthorized vehicles which have been designated but whose said distinct identities are indicated as unauthorized by said authorization data in at least one of the databases associated with the sub-zones containing that control point.

4. A method as described in claim 2, in which data regarding said designated vehicles (such as said particular active licenses distinct identities, control points location, times of designation of vehicles, etc) is additionally recorded, this data being searched for inconsistencies with regard to time and/or vehicles location, the results of this search assisting enforcement authorities in finding potential impersonations of said particular active licenses.

5. A method as described in claim 2, in which said secret cryptographic keys of at least some of said particular active licenses are distinct, each distinct key corresponding to a group of one or more said particular active license distinct identities, this, according to the level of protection required for those said particular active licenses, correspondence between said distinct secret cryptographic keys and said distinct identities being additionally required in order to cryptographically authenticate said results, so that a perpetrator in possession of a particular active license, is prevented from impersonating a particular active license with a different distinct secret cryptographic key.

6. A method as described in claim 1, in which said alert messages are prioritized, according to the control point characteristics, such as its location, alert message history, etc, and/or the time of designation of the vehicle, and/or said acquired physical characteristics if available, and/or current operational intelligence if available, improving the effectiveness of the intervention of the enforcement authorities.

7. A method as described in claim 1, in which drivers of vehicles that are classified as unauthorized, are selectively notified immediately upon the vehicles' classification by means (32) of sending a notification in the control points and means (56) of notification in the vehicle communication units.

8. A method as described in claim 1, in which at least some of the authorized vehicles are additionally provided with removable supports containing at least said secret cryptographic keys.

9. A method as described in claim 1, in which at least some of the authorized vehicles are additionally provided with supports containing at least said secret cryptographic keys, these supports planned to prevent a perpetrator from finding out, through physical penetration and/or deduction, the secret cryptographic keys they contain.

10. A method as described in claim 1, in which at least some of the authorized vehicles are additionally provided with supports containing at least said secret cryptographic keys, these supports being physically attached to said authorized vehicles, in a manner preventing their physical displacement from the vehicles and/or causing their destruction and/or eliminating the said secret cryptographic keys from said supports, in case of an unauthorized displacement attempt.

11. A method as described in claim 1, in which at least some of the authorized vehicles are additionally provided with supports containing at least said secret cryptographic keys, in such a way that all the information produced during said cryptographic action leading to a possible disclosure of said secret cryptographic keys, being exclusively contained in said supports.

12. A method as described in claim 1, in which at least some of said active licenses are additionally associated to PINs (Personal Identification Numbers), said PINs supplied to said active licenses by users in possession of authorized vehicles, said PINs being additionally required by said active licenses in order to generate said results of said cryptographic action, and/or being further required in order to cryptographically authenticate said results.

13. A method as described in claim 1, in which digital elements of a first type are used in performing the cryptographic actions of at least some of said active licenses, said digital elements of the first type being additionally required in order to cryptographically authenticate said acquired results, said digital elements of the first type being furthermore different at different times, preventing in this way the authentication of recorded and replayed said results.

14. A method as described in claim 13, in which said digital elements of the first type are based on the outputs of time clocks.

15. A method as described in claim 13, in which said digital elements of the first type are acquired by the control points and transmitted to said designated vehicles.

16. A method as described in claim 2, in which said digital elements of the first type are the elements of predefined series associated with distinct identities.

17. A method as described in claim 2, in which digital elements of a second type are generated by at least some of said active licenses, are used in performing the cryptographic actions of these particular active licenses, and are required to be different at different times in order to cryptographically authenticate said results of these particular active licenses, preventing in this way the authentication of recorded and replayed said results.

18. A method as described in claim 1, in which said control points are moreover planned to acquire a credential from the active license of each said designated vehicle, said validation key being securely extracted from each acquired credential by performing a cryptographic extraction algorithm involving an extraction key.

19. A method as described in claim 2, in which said validation key is selected from a list of validation keys, according to said determined distinct identity.

20. A method as described in claim 1, in which the cryptographic process consisting of said cryptographic actions in said active licenses and said cryptographic authentications of said acquired results, is of a symmetric type, an asymmetric type, or a combination of both.

21. A method as described in claim 1, in which at least some of said control points are further planned to associate each said acquired result to a particular designated vehicle.

22. A method as described in claim 1, in which the memory contents of said active licenses can be altered as a consequence of instructions and/or data transmitted from the control points.

23. A method as described in claim 1, in which at least some of said authorized vehicles are additionally provided with second active licenses (60/2a, 60/2b, . . . ), the first ones (60a, 60b, . . . ) being hereafter referred to as first active licenses, said second active licenses being planned to perform a second cryptographic action involving a second secret cryptographic key, these authorized vehicles being also provided with removable supports containing at least said second secret cryptographic keys of said second active licenses, at least some of the control points being additionally planned to perform dual interrogation mode, in which these control points further acquire the results of said second cryptographic actions performed by the second active licenses of said designated vehicles, hereafter referred to as second results, and a second cryptographic authentication algorithm involving a second validation key, being further performed upon each acquired said second result, additionally classifying as unauthorized vehicles which have been designated but whose said second results either have not been acquired or have not been cryptographically authenticated.

24. A method as described in claim 23, in which predetermined correspondences between said first active licenses and said second active licenses are planned, additionally classifying as unauthorized vehicles, which have been designated by a control point in dual interrogation mode, for which said predetermined correspondences have not been verified.

25. A security system for the detection and/or control of unauthorized vehicles (10a, 10b, . . . ) among a large number of authorized vehicles (12a, 12b, . . . ) within a controlled geographical zone (2), to implement the method of claim 1, comprising:
in all authorized vehicles a vehicle communication unit (50), comprising means (52) of activating the transmission of an identification message by the vehicle communication unit, an active license (60) containing a distinct identity (62), and a transmitter (54),
means of issuing (170), and of revoking (178) of active licenses (60a, 60b),
at least one database (180) containing authorization data regarding vehicles,
automatic control points (20a, 20b, . . . ), and optionally manual control points (40a, 40b, . . . ), both distributed in the controlled geographical zone (2), each automatic control point comprising means (22) of detection of all vehicles crossing a specific road section (21) in its vicinity, and each manual control point comprising means of selection (42) of vehicles by the action of an operator, the vehicles detected by the automatic control points and the vehicles selected by the manual control points being hereafter referred to as designated vehicles, both types of control points additionally comprising means (24) of activating requests for identification to the vehicle communication units of the designated vehicles, means (26) of reception capable of receiving identification messages transmitted by vehicle communication units, hereafter referred to as vehicle communication unit responses (90a, 90b, . . . ), and a controller (28) capable of associating vehicle communication unit responses to designated vehicles,
means (130) of retrieving prior data from the database (180),
means (140) of classification of designated vehicles,
at least one operations center (160),
additional means (44) in the manual control points of notifying the manual control point operator,
a communication network (100) between at least some of the control points, the database (180), the means of issuing (170) and revoking (178) of active licenses, the means of retrieving prior data (130), the means of classification (140) and the operations centers,
characterized in that:
I) the active license (60) contains in addition a secret cryptographic key (64) associated to the distinct identity (62) of the active license (60), and is planned to perform a cryptographic confirmation algorithm (66) involving at least the distinct identity (62) and the secret cryptographic key (64),
II) the vehicle communication unit response (90) comprises the result of the cryptographic confirmation algorithm (66),
III) means (70) of cryptographic authentication are planned to check for each vehicle communication unit response (90) whether or not the secret cryptographic key (64) corresponding to the distinct identity (62) contained in the vehicle communication unit response (90) was the one used in the calculation of this response (90), this action involving a validation key (74) corresponding to the same distinct identity (62), and a cryptographic validation algorithm (76),
IV) for every newly authorized vehicle, the means (170) of issuing allocate a distinct identity (62), initialize a new active license (60) to bear the allocated distinct identity (62) and a corresponding secret cryptographic key (64), and update the database (180) with information regarding the newly authorized vehicle (12),
V) the means (178) of revoking are planned to automatically (for example time dependent expiration) and/or manually modify elements in the database (180), particularly those included in a list of distinct identities of active licenses in authorized vehicles' vehicle communication units, hereafter referred to as authorized vehicle list (182), and/or a list of distinct identities of active licenses in unauthorized vehicles' vehicle communication units, hereafter referred to as unauthorized vehicle list (184),
VI) the means of retrieving prior data (130) utilize the distinct identity (62) contained in the vehicle communication unit response (90), in order to retrieve from the database (180), authorization data regarding this vehicle,
VII) the means (140) of classification utilize the data produced by the means (22) of detection, and/or the means (26) of reception, and/or the controller (28), and/or the means (70) of authentication, and/or the means (130) of retrieving prior data, to determine whether a designated vehicle is authorized or not,
VIII) means (150) of alert convey to at least one operations center (160) and/or to the means (44) of notifying the manual control point operator, an alert message containing the data provided by the means (26) of reception, and/or the controller (28), and/or the means (70) of authentication, and/or the means (130) of retrieving prior data, for at least some of the vehicles classified as unauthorized,
IX) at least some of the control points comprise in addition means (30) of acquiring physical characteristics of designated vehicles, such as photographic information, plate number, color, vehicle type, weight, etc. . . . , the means of alert (150) additionally include said acquired physical characteristics in at least some of the alert messages.

26. A system according to claim 25, in which the means (70) of authentication are additionally planned to determine the validation key (74), by utilizing the distinct identity (62) contained in the vehicle communication unit response (90), to select from a validation key list (80) containing for each distinct identity (62) a corresponding validation key (74), and the means (170) of issuing are also additionally planned to update for every newly authorized vehicle (12) the validation key list (80) with the allocated distinct identity (62) and the corresponding validation key (74).

27. A system according to claim 25, in which the vehicle communication unit response (90) additionally comprises a credential (174), the means (70) of authentication being additionally planned to determine the validation key (74), by utilizing a cryptographic extraction algorithm (86) involving an extraction key (78), in order to securely extract the validation key (74) from the credential (174) contained in the vehicle communication unit response (90), and the means (170) of issuing being also additionally planned to initialize for every newly authorized vehicle (12), the active license (60) with a credential (174) containing the result of a cryptographic binding algorithm (176) involving the validation key (74) and a binding key (172) which corresponds to the extraction key (78).

28. A system according to claim 25, in which the means (24) of activating requests for identification transmit to every designated vehicle an interrogation message.

29. A system according to claim 25, in which the means (24) of activating requests for identification comprise a trigger element in the vicinity of the control point, that is planned to be detectable by means (52) in the vehicle communication units.

30. A system as described in claim 25, which is utilized to perform additional functions such as Electronic Toll Collection, Access Control, in particular on the perimeter of the controlled geographical zone and/or any of its sub-zones, Vehicle Messaging, Fleet Management, traffic law enforcement, statistical survey, a crime investigation tool, etc.

31. A method as described in claim 13, in which said digital elements of the first type are the elements of predefined series associated with distinct identities.
